(19) United States
(12) Patent Application Publication
(10) Pub. No.: US 2005/0247206 A1
(43) Pub. Date: Nov. 10, 2005

(54) Proximity link controller for equipment and product

(75) Inventors: Lucian Hite Lyall III, Coto De Caza, CA (US); Karol Zbigniew Renau, Calabasas, CA (US)

Correspondence Address: Curtis L. Harrington, Suite 250, 6300 State University Drive, Long Beach, CA, 90815, US

(73) Assignee: Wilbur Curtis Company (CA Corporation), Montebello, CA (US)

(21) Appl. No.: 10/842,028

(22) Filed: May 6, 2004

(51) Int. Cl. A47J 31/00

(52) U.S. Cl. 99/280; 99/285

(57) ABSTRACT

An identity and possibly integrity based communication system is disclosed as a broad conceptual realization of a system especially useful with a disposable product packaging and its machinery which enables receipt of identification data incorporated into the packaging, or otherwise incorporated into the product. The receipt of information may be acknowledged to the user or surreptitiously acknowledged, and includes cases where the identification data carried may be either preserved, destroyed, or changed upon opening, or consumption of the contents in the package. The existence of the identification data may be either shown on the packaging or hidden from view regardless of whether the identification data is placed on the outside surface of the packaging, inside surface of the packaging, or within the packaging material. An integrated packaging used without further package removal is also included. Identification data includes, and is not limited to packaging number, packaging or product type contained within the packaging, size, and may include instructions on treating, using or otherwise dealing with the material or object contained in the packaging.

### FIELD OF THE INVENTION

The present invention relates to the field of device operation with recordation of event capability and more particularly to processing appliances which utilize materials to be processed and especially for identifying the grade, source, amount, characteristics of, and associated data especially as carried by containers bearing the materials to be processed.

### BACKGROUND OF THE INVENTION

Corresponding to the reduced cost of microprocessor and sensor components, apparatus of every type have been increasingly automated over the past 30 years. Areas of greatest use have been in securing operator control over equipment, followed by use of digital circuitry for diagnostic purposes. In the vast majority of utilization, such circuitry is used to enable greater user control, or to enable users and technicians to probe the internals of equipment without having to take the equipment apart.

Other microprocessors and sensors have been utilized in the entry access system. Entry access systems include card swiping, retinal identification, fingerprint recognition systems, as well as keypad entry. Entry access systems can be made to have a high level of security with the main focus upon identification and lack of ability to circumvent the system.

One major concern for equipment is its proper use. When a business purchases, owns and maintains equipment, the business owner has the responsibility to see that proper operation is achieved. Complex programs for periodic maintenance are implemented, and policies are developed to insure the long life of the equipment and to conserve operability and to minimize major repair events like overhaul. Overhaul is a partial re-building of, and in some instances a re-manufacture of all or a major portion of the equipment.

Where ownership and responsibility for operation of equipment is unified the need for a more automated manner of insuring the mode of operation is lessened, and the responsibility, honesty and control of employee agents may be sufficient. In instances where responsibility for equipment integrity exists apart from its ownership or operation, the need for additional controls presents itself.

Instances where responsibility departs from operation which may further depart from ownership are many. Where a manufacturer predicates warranty upon limiting a mode of operation or quality of process inputs, the manufacturer typically has no effective control of the equipment once it leaves the factory. Control inputs might include a minimum number and level of periodic maintenance activity, a minimum quality or grade of raw material or energy inputs, a limitation on process cycle times, a limitation on speed where speed is a variable, a limitation on temperature or a limitation on other operational characteristics.

The number and variability of restrictions or minimum requirements are boundless and highly dependent upon the type of equipment and its mode of operation. A few number of user inputs equates with the need to monitor or control based upon a correspondingly few number of parameters. Where control is completely automated, the need for extended control is can be virtually eliminated by providing completely automated operation.

However, most equipment has at least some user specified inputs. Where control of the equipment is performed through the computer interface, the operation can be intrinsically limited. Other circuitry and structures can be added to protect the equipment from external conditions. For example, interruptions in power can be minimized or eliminated for extended periods of time. One of the main inputs which cannot be intrinsically controlled for equipment are process inputs.

The nature, quality, quantity, and purity of process inputs are difficult to control even where a user tries diligently to control this input to a known standard. Further, where standards such as purity or concentration of process inputs can be advantageously adjusted, there is no suggestion that other process inputs can be compensatably adjusted to take advantage of the process material input improvement.

Even where the process input material is provided in bulk and automatically metered, there is no insurance that a lesser quality product cannot be substituted. In some cases the manufacturer can limit the process input material packaging to create a mis-match with regard to its connection to the process equipment. Such specialized process input material packaging is not always possible nor economically feasible. In most cases it is circumventable in the long term. Bulk systems are especially tempted to be circumvented because user modification will enable a mass substitution of different material.

Equipment which has any outside input, including process input material packaging inputs, are subject to error. The equipment can fall out of calibration and uneven inputs of process input material can readily occur. The objective desired which is rarely achieved is the elimination of error in amount, quality and type of process input material, along with elimination of error in equipment process operation.

The case of equipment warranty obligation separate and apart from equipment ownership and control is problematic, but in the case of loaned equipment where ownership, responsibility for proper equipment maintenance and use is separate both physically and locationally from the equipment's operation poses a particular problem. This often occurs where the more important or valuable aspect of operation is the product produced by the process input material, and where the equipment is provided for proper treatment of the process input material.

Examples of this type of arrangement are numerous, and occur more often either when the process input material is expensive relative to the sunk cost of the process equipment, or by industry standard. For example, surgical tools may be provided for use with surgical implants even though the tools may cost ten times the implant, because the tools are somewhat resistant to damage and where the number of implants to be used with the tools are many. However in the case of implants and surgical tools, much of the processing is at the discretion of the surgical practitioner.

In other cases, the equipment is provided to enable a product yield of the highest quality. In essence, the supplier of the product knows that the ultimate test for a product is its quality “as provided” even if the determination of the ultimate product quality must be provided on a business site remote from the manufacturing facility. The provider of the process input material will often provide the process equipment with a mind toward providing the highest quality product. The equipment provider knows that the use of suboptimal equipment will cause the production of an inferior product, and that if an inferior product is produced, the product consumer will blame the process input material and prefer other products.

As a result, producers of process input material will select equipment which is the best match for the process input material in terms of capability for specific products and capability to handle the variety of products the producers manufacture. Where equipment is provided, and regardless of ownership, the producer has an interest (1) in determining that the equipment has the operational capability to handle and adequately process the input material, (2) that the equipment is able to adjust to the particular type and amount of product presented, (3) that the use product which is incompatible or deleterious to the equipment is prevented or detected, (4) that all other processing variables are minimized, and (5) that the support of final product quality is accomplished at a minimal and competitive cost.

What is therefore needed is a system which enables equipment processing of process input material in a way which insures highest product quality and minimizes the potential for error resulting from causes ranging from inadvertent to deliberate. The needed solution should also contribute to the industry trend of enabling operation by persons with lesser skill levels. The needed solution should reduce the actions needed by operators, as much as possible, to the physical transport and loading of the process input material. The needed system should be as foolproof and non-circumventable as possible. The needed system should also be enabled to detect and report any instances of operation in which the intended mode of operation is circumvented.

### SUMMARY OF THE INVENTION

An identity and possibly integrity based communication system is disclosed as a broad conceptual realization of a system especially useful with a disposable product packaging and its machinery which enables receipt of identification data incorporated into the packaging, or otherwise incorporated into the product. The receipt of information may be acknowledged to the user or surreptitiously acknowledged, and includes cases where the identification data carried may be either preserved, destroyed, or changed upon opening, or consumption of the contents in the package.

The existence of the identification data may be either shown on the packaging or hidden from view regardless of whether the identification data is placed on the outside surface of the packaging, inside surface of the packaging, or within the packaging material. Identification data includes, and is not limited to packaging number, packaging or product type contained within the packaging, size, and may include instructions on treating, using or otherwise dealing with the material or object contained in the packaging.

The process contemplated herein includes receipt of the identification data by computer hardware and associated peripherals which can be at least one of (1) devices to enable the identification data to be accessed, displayed or observed on site or remotely to obtain a record of such identification data with other associated data including time, machine operation data and user information, all of which may be associated or un-associated with such identification data, (2) devices to control such machinery which may include control aspects of access to the machinery by users, details and specification of machinery processing steps, audible or visual warnings or instructions to users, supplemental acceptance of machine processing commands or environmental information from users. The realization of the product and process also includes both software, computer processors and hardware as are necessary to achieve the above aspects including electromagnetic, sonic, electrical and mechanical transmitters and receivers.

The packaging or its attached communication circuits can be set to accept inputs which were pre-set at the time the process input material and its packaging was provided, or which have been triggered by the user's deliberate manipulation of the packaging, or which have been triggered by the user's inadvertent manipulation of the packaging. Further, depending upon the inputs above, the equipment receiving identity data from the packaging or product, can mark, add data to, or destroy the data ability of the packaging. This is particularly useful in instances where potential persons seeking to circumvent the system might save old packaging for use as a data tag for attempting to circumvent the quality controls and proper instructions which have been implemented for best product production.

The method of communication may be electromagnetic at frequencies ranging from optic to radio wave, and may involve proximity triggering or deliberate triggering. Sonic, electrically conductive and mechanical contact transmitters and receivers can also be used. Further, equipment manipulation of the packaging is also possible, as in cases where the equipment opens, empties, and then alters the spent packaging or product.

### BRIEF DESCRIPTION OF THE DRAWINGS

The invention, its configuration, construction, and operation will be best further described in the following detailed description, taken in conjunction with the accompanying drawings in which:

FIG. 1 is a perspective view of one example of a unit of equipment seen as a brewer and batch product container;

FIG. 2 is a perspective view of a material package with exposed foiled conductor circuitry and optional microchip;

FIG. 3 is an overall view of a material package with a peripheral tear notch and peripheral conductor;

FIG. 4 is a plan view of an integrated unit including both raw material package and transducer for identifying the product;

FIG. 5 is a cross sectional cut away of the brewer seen in FIG. 1 and showing the integrated unit in a flow through container with the location of sensors shown;

FIG. 6 is a schematic block diagram of one possible realization for a proximity link controller for appliances and product; and

FIG. 7 is a simplified serial logic flow diagram which includes possible numbers of logic. flow and control indicia which may be utilized for the controller and system of the invention.

### DETAILED DESCRIPTION OF THE PREFERRED EMBODIMENT

The process and apparatus described herein will in concentrate on the rudimentary application of using a food service brewing apparatus in conjunction with a minimalist level interaction between the brewer equipment and process material input packaging to illustrate the advantages obtainable even where low controllability of the process material input is present.

One realization of a proximity link controller for appliances and product is shown as a brewer 21, such as may typically be utilized with coffee or tea is a device which introduces a controlled flow of hot water through a flow through container 23 and into a batch storage container 25 which may be enabled for further dispensing. In this configuration, the flow through container 23 is completely accessible by the user since it can be removed, cleaned, have the nature and quality of any filtration specified and installed, as well as the coffee or tea process material introduced into it.

Brewer 21 may have a variety of structures mounted high and in view on an access panel 27. Typically an on/off switch 31, indicator lights 33 and 35 may be present. One or more sensor/transmitter structures 37 and 39 may be present as stand-alone structures or they may be hidden behind the panel.

Sensor/transmitter structures 37 and 39 may be optical, electromagnetic, sonic or may be in the form of a mechanical key. In the case of an antenna, any sensor structures also usually double as a transmitter structure. Preferably, and for purposes of illustration, the structures shown will be related to an electromagnetic system, especially in the radio-frequency domain, and will take advantage of energy induction, frequency transduction and alterations to logic and circuitry as may be obtained by such structures and energies. As by example, an electromagnetic sensor structure may be in the form of an antenna structure embedded inside the material of the dielectric front panel. The choice of specific frequency, and structure for sensor/transmitter structures 37 and 39 will be dictated by factors including communication, location on the equipment (brewer 21) and the need for user convenience and based upon the type of interaction needed.

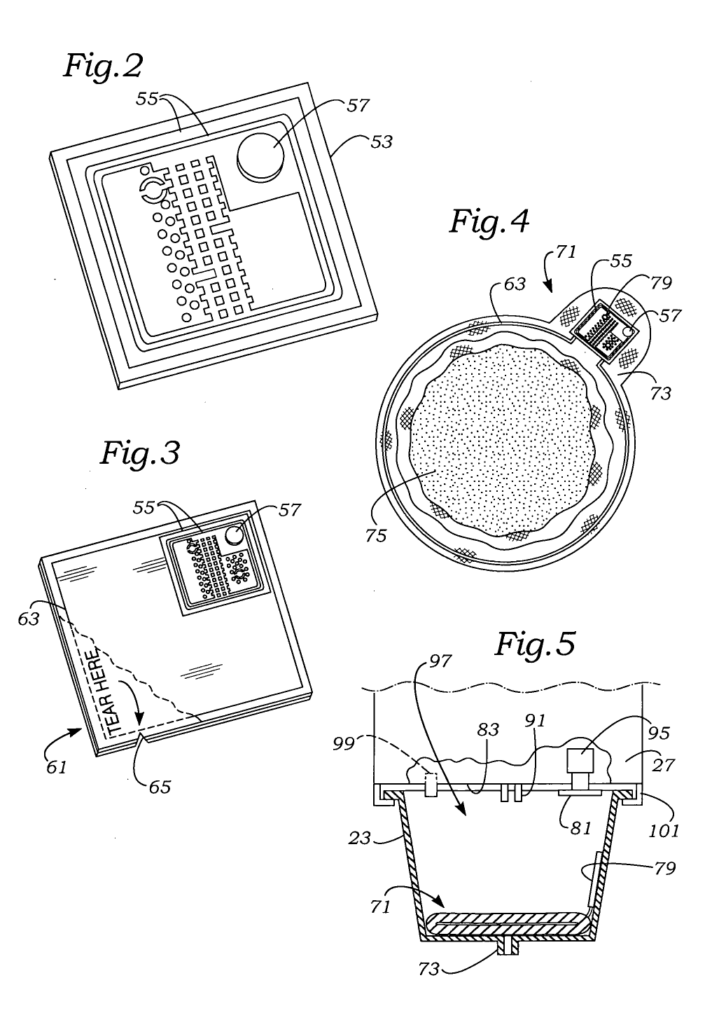

Referring to FIG. 2, a material package 51 is shown as an envelope 53 having a foil added conductor set 55, and an optional digital chip 57. Foil added conductor set 55 may have structures which are resonant over certain frequencies. Where the structures operate in a purely analog manner, the information can be impressed by cutting out certain lengths of conductor to cause one or more resonant frequencies to shift. The conductors set 55 is shown as having two small pieces of the central lattice missing to create some analog frequency selective effect. Other structures seen are shaped and located in places to create a characteristic set of frequencies or frequency responses which may alone carry the information necessary. It is preferable that the envelope 53 be made from a material having characteristics which are compatible with the operation of the conductor set 55. Where the realization of the material package 51 is that of a completely analog circuit, the lengths, orientation and placement of the conductor set 55 may completely specify the information data, especially by a combination of analog frequencies. In addition or in the alternative, the conductor set 55 may be strobed with a number of frequencies with one or more output response frequencies occurring only in response to certain input frequencies. This would create another analog dimension in which digital logic could be filled in based upon input frequencies with the presence of output frequencies indicating a logical “1” and the absence of a response indicating a logical “0”.

The presence or absence of a combination of analog frequencies out of a set number of possible analog frequencies can correspond to a digital numeric representation. In the alternative, a mixture of analog and digital data may be used to further help prevent circumvention of the proper operation, proper identification and access. Digital chip 57 could be used to switchably delay the response frequencies as a further method of impressing data on a return signal.

The foil added conductor set 55 and optional digital chip 57 will likely not be self powered and therefore may be configured to react as a transponder fashion. A transponder is typically a device for which active interrogation must be initiated in order that data may be received from it. Initiation is typically performed under the control of the receiving unit. The mode of transpondence at its simplest may be energization in one form of energy which is conductively transduced into another form or forms of energy which indicate identity.

Even a completely passive foil added conductor set 55 can have a unique identifier. Each foil pattern can be altered to give a unique response which can be decoded to show a unique identification. Such alteration can include the simple omission of one of a number of conductors at the time the foil added conductor set 55 is added to a supporting structure. Alteration can also include the varying of lengths of conductors formed as antennas so that they radiate at a different frequency. The energy for the radiation will typically include energy at another frequency which is received from another subset of the foil added conductor set 55 which was transmitted from a receiving unit. The receiving unit may typically synchronize an energy output strobe to the expected timing of receipt of the transponded signal.

In more complex realizations, a provided form of energy may energize an optional digital chip 57 which may then, under conditions of power, operate to communicate the identity of the package 51 in a variety of communication modes. In this case, the receiving unit which receives the information may further instruct the optional digital chip 57 to disable itself once the information is confirmed as having been received from the receiving unit.

A powered optional digital chip 57 may be used, but may be cost prohibitive for instances where it is disposed with the packaging. A powered optional digital chip 57 will more likely be used for products and raw materials which are of greater value than bulk food raw materials, and especially where it is desired to have a record of the process conditions prior to utilization.

Some of the analog indicia which can be transmitted from the packaging includes a mix of frequencies which have a binary meaning; a mix of impedances causing logic delays in the echo signal; a differing set of frequencies or delays in response to being strobed by a series of frequencies and more. Further, it is known that energy from the sensor/transmitter structures 37 and 39 can be used to power transmission of identifying signals from the packaging 51, and that the sensor/transmitter structures 37 and 39 can also input analog signals which can alter the signal output of the conductor set 55 of the material package 51.

Alteration can be accomplished by inputting selected frequencies of energy into the conductor set 55 to cause resistive heating and failure in one or more of the conductors. Failure of conductive continuity can cause a range of cessation characteristics from changes in conductor length to alterations of conductor path. In the microwave frequency domain, the change of a conductors length alone is enough to change its resistive , inductive and capacitive impedance. Short circuiting or open circuiting conductors lying adjacent to other conductors can also affect impedance.

Where the optional digital chip 57 is used, the ability to logically respond is also added. At its most rudimentary, the digital chip 57 may be used as a switch for controlling the conductor set 55 to control the conductive states of the conductor set 55 to indicate different responses. At a more advanced level, the digital chip 57 may be used as a switch for controlling the conductor set 55 to control the conductive states of the conductor set 55 to indicate different responses. Still more advanced would be the ability to respond with stored information in a memory which does not lose information in the un-powered state.

If the integrated circuit carries its own power supply, it could report the conditions of its environment including temperature, and time in transit as well as any other sensors mounted on board. This is simply to illustrate the range of options available, but for most products simple identification information is all that is needed. The cost and benefit of using a full powered microprocessor must be weighed against the benefits.

The fact that capabilities are present in the product packaging should not detract from the heart of the system herein, which is placing the data collection function with the equipment, and in the possible incorporation of some gatekeeper function and preferably some intelligence function in terms of product recognition and the provision of a process response based upon the type of product provided. In accord with the example given, the brewer 21 may be enabled to recognize a material package 51 for coffee different than ever for a material package 51 for tea and to change the rate and temperature of water addition best for the coffee or tea product. Further differences in operation could be attained in reaction to the volume of process material in the packaging. For a large package 51 (and correspondingly large amount of process material) the brewer 21 would allow a larger volume of hot water to pass through the flow through container 23 than would be the case for a smaller package 51.

The gatekeeper function could be exemplified by the provision of a package of instant tea, for example. Where a package of instant tea lacks the foil added conductor set 55 the sensor/transmitter structures 37 and 39 will either detect a package which is unauthorized or will not react at all. If detection is required for operation, the brewer 21 will not operate. Where the presence of a package is sensed, such as a requirement that the package be brought in close proximity to the access panel 27 where the proximity of a package is sensed but no identifying information is received by sensor/transmitter structures 37 and 39, brewer 21 will not operate, and may send produce a message to the user to select another package. The use of a proximity indicator, such as the covering of a light sensor can be used to “train” personnel to challenge the brewer 21 with product packaging. Audio can further be utilized to remind personnel of any actions which are needed to be taken.

For example, where a user selects a material package 51 and places it in close proximity to the access panel 27, it may recite some acknowledgment to the user, such as a recitation of the type of contents in the packaging, or some recitation relating to the amount of product which will be produced. It may state that the packaging 51 is not allowed where it should be used with a different machine or brewer 21. In the event that the material package 51 is proper, the brewer 21 may also audibly set forth instructions for use, an especially valuable function which may be switched on for training new users.

Referring to FIG. 3, a package 61 is shown in which a peripheral conductor 63 extends about the periphery of the package 61, especially in the area in which an easy opening nick 65 is placed. As can be seen, the peripheral conductor 63 is positioned so that opening the package 61 at the nick 65 will cause a break in the continuity of the peripheral conductor 63. This configuration will work well in instances where it is desired not to include the ability to have energy from the access panel 27 to alter the foil added conductor set 55. It also insures the foil added conductor set 55 is disabled upon the opening of the package.

In one possible normal mode of use, the brewer 21 may be either turned off or placed in standby. In this mode the hot water warmer will be disabled while enabling the sensor/transmitter structures 37 and 39 and a central processor (not shown) within the brewer 21 to receive data. The package 61 is brought within a close enough proximity to the sensor/transmitter structures 37 and 39, as well as any sensors behind the front panel 27 to enable the data from the package 51 to be “read” or transmitted from the package 51 to the sensor/transmitter structures 37 and 39.

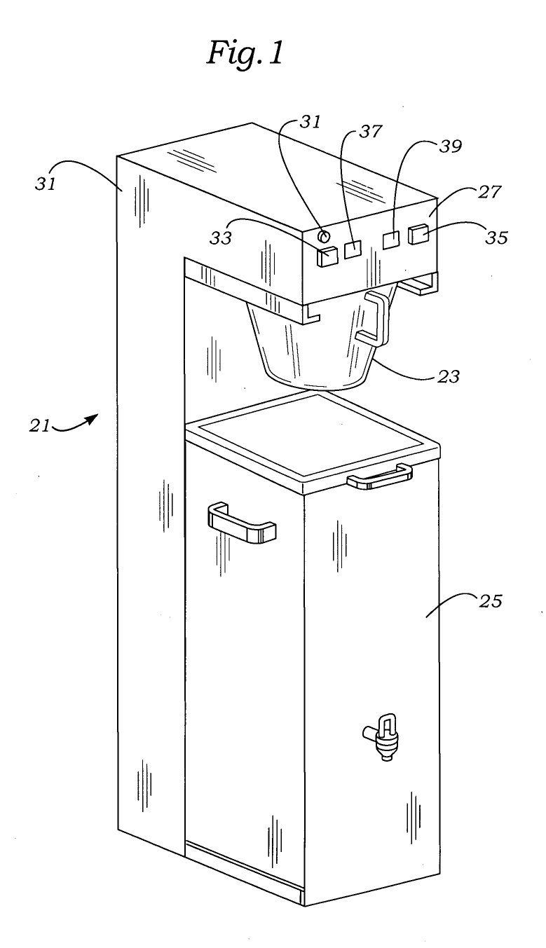

It may be preferable to instruct that the storage for the packages 51 be remote from the brewer 21 to insure that multiple readings are not encountered. In the alternative, a place may be provided for the package 51 to fit, with the sensor/transmitter structures 37 and 39 or sensor behind the front panel 27 oriented to make a more direct or more limited communication with the foil added conductor set 55 and or the optional digital chip 57. The use of positioning will help to reduce the possibility of multiple data pickup and also enable the lessening of output energy for energization of the foil added conductor set 55. In the configuration of FIG. 1, the package 51 may be presented within an inch or two of the front panel 27 to obtain a reading.

The next step could be the initiation of further audible or visual instructions to the user. In the alternative, the next step could be the automatic enablement of the brewer 21 while giving the user time to open the package 51, prepare a filter (not shown) for the flow through container 23, fill the filter, and load the flow through container 23 into the brewer 21. The next step would then be activation of the brewer 21 by a manual switch which was activated based upon proper identification of the package 51.

Further, the brewer 21 will begin its processing in response to the amount and type of product in the package 51. The processing of the brewer 21 in response to the identity of package 51 will be optimized to produce the highest quality product. For each process cycle, a microprocessor (not shown) within the brewer 21 will record the type and amount of product produced. The use of the peripheral conductor 63 to disable the ability of the package 61, or the use of energy to either disable or change the foil added conductor set 55 to indicate that the identifying information has been read once and so that the package 51 cannot be used to again transmit information. This prevents a user from re-using a spent package 51 to fool the brewer 21 to mis-process input material in the same manner as the input material which was within the package 51.

The negative impacts from enabling operation of any equipment in a manner mis-matched from the product are many. From an advertising perspective many types of processing equipment are placed for prominent view by customers. Where the input material is mis-process from not being identified and processed properly, the poor product is ascribed to either the advertised product or advertised machine, such as brewer 21. Companies and business who promote brand recognition will not be served by not being unable to produce the best product possible through the loss of control at the processing point. Further, a producer may produce the best product possible, but by allowing the product to be treated without restriction, the producer could just as well produce a sub-standard product as its reputation will suffer just as much.

Further, without the restrictions placed on the processing machinery, and particularly where the machinery is prominently placed, palming off will be more likely to occur. Where the operator is able to introduce a lesser quality product, and especially a product which may be mis-matched with the processing cycle, the user denigrates and destroys product quality, defrauds the public, and in some cases defrauds the provider of the processing equipment, in this case brewer 31. As a result of this, it is important to alter the package 51, 61 to insure that only one activation of the process machinery is possible, or at least practicable for each package 51, 61 of the raw material consumed.

Raw sabotage is always possible. Users could misappropriate the raw material from the package 51,61 and substitute a lower quality material. Users could also fail to use all of the materials in the package 51,61. Large scale counterfeiting of the identity information of the packages 51,61, could be made. An electronic transducer could be made to mimic the information on a package 51,61. However, all of these methods would likely not be able to completely emulate the production numbering system of the manufacturer. At length, the utilization of the brewer 21 would not match the proper manufacturing codes and sequence of product delivered to the location. In the long term, the system of FIGS. 1-3 would not be easily circumvented. Further, since the incentive to deviate from normal practice is not overwhelming, the utilization of the system of FIGS. 1-3 should be sufficient to result in very little cheating and a statistical guarantee of proper processing for manufacturers.

In some instances, a closer or more automatic control may be desired. It should be noted that the foil added conductor set 55 can be added to almost any sort of substrate. Some process material is provided in its own mesh bag either with or without a sealed exterior package. In the case of coffee or tea, an outer packaging wrapper is desirable in order to maintain product freshness. Referring to FIG. 4, an integrated unit 71 including a mesh bag 73 enclosing a powder product 75 is shown. A transducer 79 can be a foil added conductor set 55 directly to the mesh bag 73 material, or it can include a microprocessor 57 encased in a water proof container or melt welded to the mesh bag 73 material.

The provision of a more direct connection between the identity structure and the product to be processed will enable a more automatic processing, with greater elimination of user intervention between identity and processing, and it will either allow a mode of information disablement more directly related to processing or it will somewhat eliminate the practical need for information disablement.

Integrated unit 71 can also have an optional peripheral conductor 63 to help prevent the transducer 79 from being removed from the remainder of the integral unit 71. In lieu of a conductor, the same principles can be achieved by providing conductance connections between the mesh bag 73 and the transducer 79 which would render the transducer 79 inoperative upon removal from the remainder of the mesh bag 73. Where the material in the mesh bag 73 is dissolved completely through, the mesh bag 73 and transducer 79 might be used again. However, where identification numbers either for each integral unit 71 or for production lots of integral units 71 are used and recorded by the process equipment such as brewer 21, repeated use of a same identity datum would expose the circumvention. Where the equipment such as brewer 21 is set up to dis-sallow operability, some method to indicate use is desirable. Where integral units 71 have individual identifiers, the equipment such as brewer 21 can be programmed to permit one use per individual identifier.

In the structures of FIGS. 2 and 3, the packaging and product were separable before use. The integrated unit 71 is dropped directly into the flow through container 23, as will be shown. This enables integrated unit 71 to be in place before processing begins. In the process of brewing, the integrated unit will experience moisture and a temperature rise. In addition to the possibility of using individual identifiers for which equipment such as brewer 21 would prohibit re-utilization, these two environmental effects can be used to disable the ability for re-use by disabling the information data capabilities of the transducer 79.

As examples of disablement which may occur as a direct and natural consequence of being exposed to process conditions, the transducer 79 may contain a moisture sensor, or it may include a water soluble connection break or a temperature acting connection break so that both the product and the transducer 79 may not be re-used or the data again extracted.

Referring to FIG. 5, a sectional view of the front of the brewer 21 illustrates not only how an in-place reading of the identifying information might take place, but also how physical isolation and a requirement for physical isolation can enhance the security of the system of brewer 21. The front access panel 27 is seen, along with a sectional view of flow through container 23 which is contains the integrated unit 71. The transducer 79 is shown as simply resting to one side.

Above the flow through container 23, a window 81 is supported by what is normally expected to be a metal wall 83. The entire wall 83 could be made of the same material as window 81, but window 81 enables an isolation and focussing of the entry of electromagnetic energy if needed, as well as a minimization of the amount of non-metallic material if necessary or advantageous to the processing structure.

In a brewer 21, a drip nipple 91 is mounted in the wall 83 to enable gravity flow of a stream of hot water onto the integrated unit 71, with brewed product to gravity flow through a lower drip nipple 93 at the bottom of the flow through container 23. A sensor/transmitter 95 is located behind the window 81, and is enabled to send and receive into a space 97 within and between the flow through container 23 and the metal wall 83.

The sensor/transmitter 95 may be different than the sensor/transmitter structures 37 and 39 as the sensor/transmitter 95 can be set to work within a known environment of known size and surroundings. Having the advantage of completely specifying a micro-environment of space 97 enables the power and frequency to be set to completely bathe the space 97 with the energy necessary to power the transducer 79, as well as to insure that any signal from either foil added conductor set 55 or optional digital chip 57 is received back through the window 81 by the sensor/transmitter 95.

To complete the limited access, a switch 99 operates by closing when the flow through container 23 is in place. Typically a flange 101 supports an edge of the flow through container 23 as the flow through container 23 is slid like a drawer for a short distance rearwardly under the metal wall 83. Once the flow through container 23 is pressed back into place, optional switch 99 closes to permit the operation of the sensor/transmitter 95 after the flow through container 23 is in place.

The use of a closed space 97 helps to isolate the electromagnetic signal both transmitted to and received from the transducer 79. This provides an additional measure of safety and signal isolation, and does not depend upon a worker to place the transducer 79 in any particular position in front of one or more sensor/transmitter structures 37 and 39. Further, where processing is set to start only when recognition occurs, the conditions within the closed space 97 will be known. In addition, where an input of energy is required to disable further use of the transducer 79, this energy input can be more efficiently introduced. The energy required will be more concentrated within the closed space 97 while being isolated within the closed space 97.

Again, the disabling energy can be sonic, optic, or electromagnetic. One electromagnetic possibility is to bathe the closed space 97 with a frequency matched with a resonant network carried among a portion of the foil added conductor set 55 to induce overheating and failure of one or two conductors in much the same way that a resistor burns out. Sonic or optic energy can be used to change conductance or continuity of conductors which are manufactured to have pre-set sensitivity to those disabling forces.

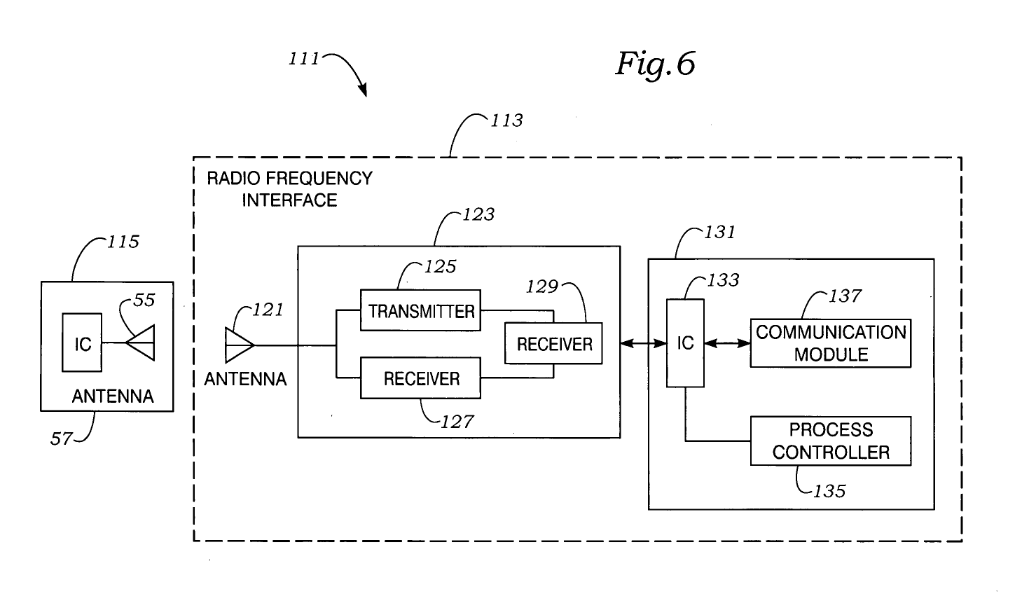

Referring to FIG. 6 a schematic illustrates one possible realization for a proximity link controller for appliances and product. A proximity link controller 111 has some form of housing boundary limit 113 which may vary depending upon the application, the need for mobility, and the physical demand for component separation or compartmentalization. The housing boundary limit 113 is within an effective distance from a separate transducer 115. This effective distance is achieved by either having a user place the separate transducer 115 in front of a sensor/transmitter structures 37 and 39 seen in FIG. 1, or by providing a more controlled space such as a closed space 97 seen in FIG. 5. Where the user controls the separation, some audible signal is preferred to let the user know that the receiving unit has identified the data from the separate transducer 115 and that further processing is now enabled.

The transducer 115 may be equivalent to the structures shown in FIGS. 1-5 with respect to the material package 51, foil added conductor set 55 and/or optional digital chip 57, but which are shown in FIG. 6 in schematic form. The housing boundary limit 113 will vary from application to application. Where the processing equipment is extended, as in the case of a skid mounted plant, the housing boundary limit 113 may be simply provided as a user interface. In the case of the brewer 21, the housing boundary limit 113 will likely be provided compactly just behind the access panel 27.

An antenna 121 will have a shape depending upon the choice of materials for the housing boundary limit 113 with due consideration taken for the frequency and mode of modulation chosen to transmit the identifying information. The antenna 121 is connected to a transceiver 123 which may include both a transmitter 125 and a receiver 127, both of which are shown as connected to the antenna 121. A modem 129 is shown connected to both the transmitter 125 and receiver 127, and serves to set the modulation mode for the signal to be transmitted and received.

Modem 129 is connected to a computer control 131 which may include a microprocessor 133 which may have full digital capabilities similar to a microcomputer, to record the identity of the signals received through the transceiver 123, and record other indicia such as time, other processing characteristics, and type and size of raw material used. Where the gate keeper function is enabled, the microprocessor 133 will also connect to a process controller 135 which is connected off site to the physical part of the process machinery, in this case to the remainder of the operable portions of the brewer 21. The physical part of the process machinery in the case of brewer 21 will include a water flow valve or solenoid, and a water heating apparatus(not shown). A communication module 135 is connected to the microprocessor 133 and enabled to download data and information stored in the microprocessor 133. Microprocessor 133 may also include peripherals such as floppy drives, CD Rom, tape output and telephonic and Internet communications. Computer control 131 also includes components not shown including process controller 135 connections and power for all the components and devices seen in FIGS. 1-6.

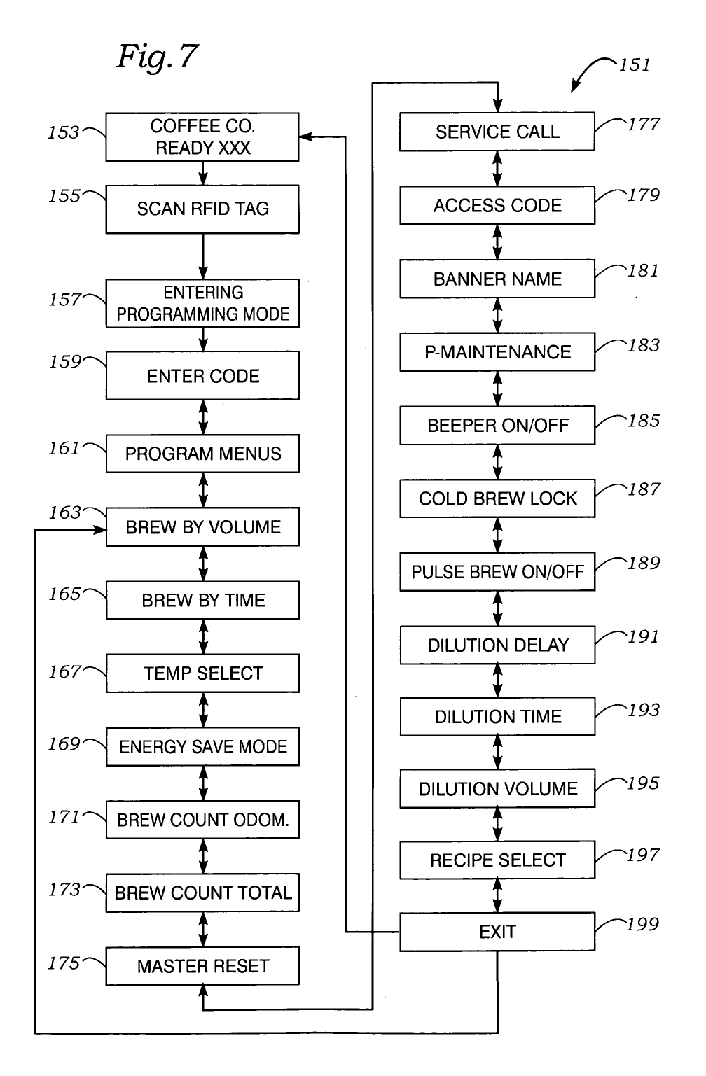

Referring to FIG. 7, a simplified computer block diagram logic flow menu 151 for use with the devices seen in FIGS. 1-6, and especially microprocessor 133, is shown. Beginning at a “Ready” block 153, a banner indicated as “Coffee Co.” may be shown, along with a number of brews remaining on the process equipment seen as “XXX” and may include the number remaining before servicing, or the number remaining before being re-set remotely or locally, or in the alternative, it may show the brews for the day or the brews since last servicing.

The logic may thin flow to a “scan RFID tag” block 155 where RFID (radio frequency identification) scanning may be initiated by simply having the user turn on the on/off switch 31, or the sensor/transmitter structures 37 and 39 could be set to operate by a change in light when a material package 51 is brought near. In the alternative, a power pulse may strobe every 5 seconds, but this is not the preferred method as it will slow the user down in having to wait for a strobe.

Here the product code which is returned from package 51 is entered into the microprocessor 133. In the simplest embodiment, to minimize the information necessary to be carried by the package 51, a simple product code could be used. The product code could then be compared to a look-up table to indicate the amount, strength, type of product, as well as a list of specific processing steps necessary to treat the raw material product, such as to brew coffee or tea, in this example.

The logic then flows to an “Entering Programming mode” block 157 and then to a series of blocks including an “Enter Code” block 159. The code entry is an access code to enable selected users to get into the programming mode. The use of four digits has been found to yield an acceptable number of access possibilities. This allows a user to enter a custom access code so a competitor, unauthorized user or even a non-technician using the same equipment can't access the programming mode and possibly change the specific programming for a unit of equipment.

The logic next flows to a Program Menu block where the appropriate program menu is selected based upon the product number. More information could be gathered from the package 51, but where a system 111 is designed so that the package 51 is simplest, it will also be the least costly in terms of packaging cost.

Within the program menu, the processing may proceed automatically or the user may be given the opportunity to make some process decisions. Some of the other aspects include the remaining blocks shown underneath the programming menu block 161 and include a “Brew by Volume” block 163; a “Brew By Time” block 165; a “Temp Select” block 167; an “Energy Save” block 169; a “Brew Count Odom” block 171 which would have information on the total number of brews (as an odometer count) for different categories of time; a “Brew Count Total” block 173 which give a more global number of brews; a “Master Reset” block 175, which could be used to re-set the system ill; a “Service Call” block 177 where service may be indicated to the user or an independent communication from the communication module 137 initiated; an “Access Code” block 179 where service or programming access can be entered; a “Banner Name” block 181 where entry of the indicated advertising banner for electronic advertising or simple identification to the user may be had; a “P-Maintenance” block 183 which may indicate the need for periodic maintenance or may result in an independent communication from the communication module 137 be initiated; a “Beeper On/Off” block 185 to either cause an announcement of cycle milestones to be audibly and/or visually communicated to the user; a “Pulse Brew On/Off” block 189 in which a periodic mode of operation may be entered; a “Dilution Delay” block 191 in which dilution of additional hot water through the flow through container 23 is made to make up for evaporation loss; a “Dilution Time ” block 193 in which the flow of dilution water can be controlled by time; a “Dilution Volume” block 195 in which dilution volume can be specified, a “Recipe Select” block 197 in which the recipe type can be specified; and an “Exit” block 199 in which the logic flow is re-directed to the “Ready” block 153 to again make the menu of FIG. 7 available.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

1. A proximity link controller for process equipment comprising:
a unit of process equipment;
an identity reader having at least one of sensor and transmitter structures connected to said unit of process equipment;
a material package containing material to be processed and having an information identifier readable by said identity reader;
a computational processor connected to said identity reader for receiving, classifying and acting upon said process equipment in response to said information identifier.

2. The proximity link controller for process equipment as recited in claim 1 wherein at least one of said computational processor and said information identifier contains detailed information for operating said process equipment.

3. The proximity link controller for process equipment as recited in claim 1 wherein said information identifier is analog.

4. The proximity link controller for process equipment as recited in claim 1 wherein said information identifier is at least partially digital.

5. The proximity link controller for process equipment as recited in claim 1 wherein said packaging is such that said material to be processed by said unit of process equipment may be performed through said packaging.

6. The proximity link controller for process equipment as recited in claim 5 wherein said unit of process equipment is configured to isolate said material to be processed and said information identifier from a user before said computational processor is enabled to perform at least one of the receiving said information identifier, classifying said information identifier and acting upon said process equipment.

7. The proximity link controller for process equipment as recited in claim 1 wherein said unit of process equipment is configured to enable its operation only when said material package containing material to be processed has an proper identifier.

8. The proximity link controller for process equipment as recited in claim 1 wherein said identifier associated with said material package containing material to be processed can be disabled.

9. The proximity link controller for process equipment as recited in claim 8 wherein said identity reader can disable said identifier associated with said package.

10. The proximity link controller for process equipment as recited in claim 9 wherein said a computational processor is programmed to disable said identifier associated with said package after reading said identifier.

11. The proximity link controller for process equipment as recited in claim 8 wherein said identifier associated with said package is arranged to be disabled upon opening of said package.

12. The proximity link controller for process equipment as recited in claim 9 wherein said opening of said package is by tearing said package.

13. The proximity link controller for process equipment as recited in claim 1 wherein said computational processor is programed to disable said information identifier immediately after said information identifier is read.

14. The proximity link controller for process equipment as recited in claim 1 wherein said process equipment is a brewer for introducing hot water into contact with said material to be processed.

15. The proximity link controller for process equipment as recited in claim 13 wherein said material to be processed is coffee and wherein processing is by brewing and wherein said brewing is performed while said coffee remains within said packaging.

16. The proximity link controller for process equipment as recited in claim 15 wherein said brewer includes a flow through container for isolating said coffee and said packaging.

17. The proximity link controller for process equipment as recited in claim 16 wherein said computational processor allows said identity reader to read said information identifier only when said flow through container is in a position in which brewing can occur and wherein said packaging is isolated within said flow through container.

18. A process of controlling process equipment comprising the steps of:
in a material package containing material to be processed and having an information identifier readable by an identity reader, reading said information identifier;
enabling a pre-selected processing sequence in a unit of processing equipment in response to reading said information identifier and which corresponds to at least the identity of the type and amount of material to be processed; and
disabling said information identifier to prevent its further use.

19. The process of controlling process equipment as recited in claim 18 and further comprising the step of isolating said material package containing material to be processed within said unit of processing equipment as a prerequisite to said reading said information identifier step.

20. The process of controlling process equipment as recited in claim 18 wherein said reading said information identifier step is performed using electromagnetic energy.
